(19) United States
(12) Patent Application Publication
(10) Pub. No.: US 2020/0040459 A1
(43) Pub. Date: Feb. 6, 2020

(54) PLATED OBJECT AND METHOD OF FORMING THE SAME

(71) Applicant: NANYANG TECHNOLOGICAL UNIVERSITY, Singapore (SG)

(72) Inventors: Hirotaka SATO, Singapore (SG); Jing ZHAN, Singapore (SG); Chun Long Desmond TAN, Singapore (SG)

(21) Appl. No.: 16/603,186

(22) PCT Filed: Apr. 4, 2018
(86) PCT No.: PCT/SG2018/050170

§ 371 Date: Oct. 4, 2019

(30) Foreign Application Priority Data
Apr. 4, 2017 (SG) 10201702776V

(51) Int. Cl. C23C 18/34; C23C 18/44; C23C 18/40; C23C 18/18; B01J 23/50; B01J 23/44

(52) U.S. Cl. CPC C23C 18/34; C23C 18/44; B01J 23/44; C23C 18/1893; B01J 23/50; C23C 18/40

(57) ABSTRACT

The invention relates to a method of forming a plated object comprising forming an electrically conductive layer on a surface of a substrate, providing a catalyst on or in contact with the electrically conductive layer and contacting the catalyst with an electroless plating bath solution to form a metallic layer over the substrate. In particular, the electrically conductive layer comprises a conductive carbon material of reduced graphene oxide; and the catalysts include palladium or silver.

### CROSS-REFERENCE TO RELATED APPLICATION

This application claims the benefit of priority of Singapore application No. 10201702776V filed on Apr. 4, 2017, the contents of it being hereby incorporated by reference in its entirety for all purposes.

### TECHNICAL FIELD

Various aspects of this disclosure relate to a plated object. Various aspects of this disclosure relate to a method of forming a plated object.

### BACKGROUND

Since electroless plating is devised by Brenner and Riddell in 1947, it has been widely used as a deposition method in various industries for metal coating. Electroless deposition can reduce metallic ions to their metallic state in the presence of a chemical reducing agent in solution. Electroless disposition requires no additional power source and no external electrodes present for the deposition (compared to electrical deposition which requires both a power source as well as external electrodes).

Instead, in electroless deposition, the electrons are provided by the reducing agent through chemical reaction. In the presence of inhibitors in a metallic salt solution, the reaction can be controlled to occur only on the catalytic surface rather than throughout the solution. In electroless plating, palladium (Pd) is one of the common materials used as a catalyst. The Pd catalyst deposited on the substrate is a cost barrier to the widespread use of electroless deposition because the market price of Pd is considerably high.

### SUMMARY

Various embodiments may provide a method of forming a plated object. The method may include forming an electrically conductive layer on a surface of a substrate. The method may also include providing a catalyst on or in contact with the electrically conductive layer. The method may additionally include contacting the catalyst with an electroless plating bath solution to form a metallic layer over the substrate, thereby forming the plated object.

Various embodiments may relate to a plated object. The plated object may include a substrate. The plated object may also include an electrically conductive layer on with the substrate. The plated object may further include a catalyst on or in contact with the electrically conductive layer. The plated object may additionally include a metallic layer over the substrate.

### BRIEF DESCRIPTION OF THE DRAWINGS

The invention will be better understood with reference to the detailed description when considered in conjunction with the non-limiting examples and the accompanying drawings, in which:

FIG. 1 is a schematic illustrating a method of forming a plated object according to various embodiments.

FIG. 2 is a schematic illustrating a plated object according to various embodiments.

FIG. 3 is a schematic showing (A) an electroless deposition process on an electrically non-conductive substrate; (B) an electroless deposition process on an electrically conductive substrate; and (C) an electroless deposition process on a reduced graphene oxide (RGO) coated electrically non-conductive substrate according to various embodiments.

FIG. 4 illustrates (A) an image showing nickel (Ni) plated over a conductive substrate having two regions or domains of palladium (Pd) catalysts (indicated by circles) after electroless deposition, and (B) an image show a conductive substrate without palladium (Pd) catalyst after electroless deposition. The conductive substrate may be a copper (Cu) sheet or foil.

FIG. 5A is a plot of intensity (in arbitrary units or a.u.) as a function of angle 2θ (in degrees or °) showing the X-ray diffraction (XRD) patterns of graphene oxide (GO) before and after treatment with Na₂H₂PO₄ according to various embodiments.

FIG. 5B is a plot of intensity (in arbitrary units or a.u.) as a function of Raman shift (in per centimeter or cm⁻¹) showing the Raman spectra of graphene oxide (GO) before and after treatment with Na₂H₂PO₄ according to various embodiments.

FIG. 6 shows a table show the starting conditions used to process different samples of electrically non-conductive quartz (SiO₂) substrates: Sample (i) high loading of palladium catalyst, Sample (ii) low loading of palladium catalyst, and Sample (iii) low loading of palladium catalyst but with the substrate coated or covered with reduced graphene oxide (RGO) according to various embodiments.

FIG. 7A shows a transmission electron microscopy image of Sample (i) indicated in FIG. 6 after being treated with PdCl₂.

FIG. 7B shows a transmission electron microscopy image of Sample (ii) indicated in FIG. 6 after being treated with PdCl₂.

FIG. 7C shows a transmission electron microscopy image of Sample (iii) according to various embodiments indicated in FIG. 6 after being treated with PdCl₂.

FIG. 8A is a plot of deposition amount (in micrograms or μg) as a function of deposition time (in seconds or s) showing the variation of the electroless deposition amount of nickel over the substrate over time for various samples after the different catalyzation processes according to various embodiments.

FIG. 8B is a magnification of the plot of FIG. 8A showing the electroless deposition amount of nickel over the substrate over time for Sample (ii) and the “Blank” Sample referred to in FIG. 8A.

FIG. 9A is a plot of mass activity (dimensionless) as a function of deposition time (in seconds or s) showing the variation of mass activity for Sample (i) and Sample (iii) according to various embodiments as referred to in FIG. 6 over time.

FIG. 9B is a magnification of the plot shown in FIG. 9A.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or objects are analogously valid for the other methods or objects. Similarly, embodiments described in the context of a method are analogously valid for an object, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The object as described herein may be operable in various orientations, and thus it should be understood that the terms “top”, “topmost”, “bottom”, “bottommost” etc., when used in the following description are used for convenience and to aid understanding of relative positions or directions, and not intended to limit the orientation of the object

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

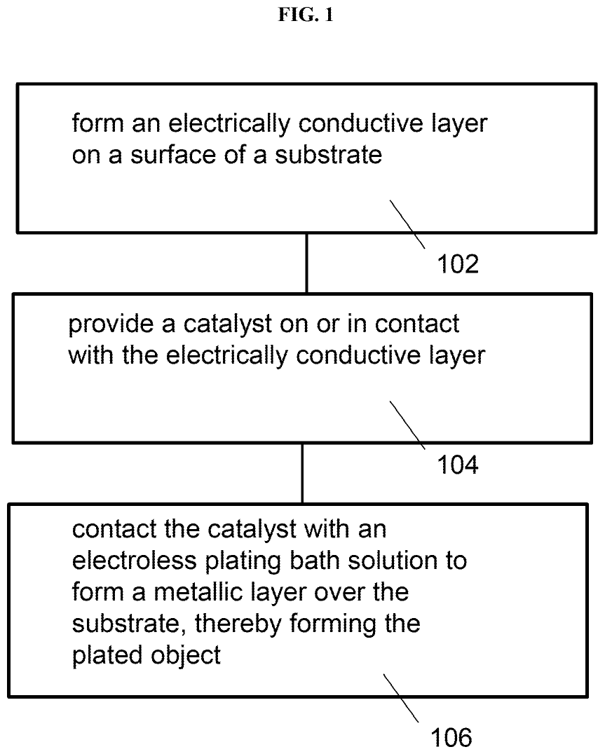

FIG. 1 is a schematic illustrating a method of forming a plated object according to various embodiments. The method may include, in 102, forming an electrically conductive layer on a surface of a substrate. The method may also include, in 104, providing a catalyst on the electrically conductive layer. The method may further include, in 106, contacting the catalyst with an electroless plating bath solution to form a metallic layer over the substrate, thereby forming the plated object.

In other words, a method of plating a substrate may be provided. The method may first involve forming an electrically conductive layer on the substrate before forming or depositing a suitable catalyst over the substrate and in contact with the electrically conductive layer. The method may further include forming a metallic layer to plate the substrate.

Various embodiments may seek to reduce the cost of electroless plating. Electroless plating, also known as chemical or auto-catalytic plating, is a non-galvanic plating method that may involve several simultaneous reactions in an aqueous solution, which may occur without the use of external electrical power. During the plating process, a thin layer of catalyst, such as palladium (Pd), may be required to be adhered to the substrate. The substrate with the adhered catalyst may be then immersed in the electroless plating bath solution, which forms a metallic layer, i.e. a layer of the plating metal/alloy, over the object. The catalyst may be used only once to initiate the plating and may be subsequently be covered by the continuous build-up of the electroless metal film and cannot be reused. The cost of electroless plating may be reduced substantially if the amount of catalyst used can be reduced without affecting the plating process.

The metallic layer may facilitate the transport and/or transfer of electrons, thus facilitating the electroless deposition process.

In the current context, a “substrate” may refer to an unplated object. The substrate may be of any suitable shape and size.

In the current context, an “object” may refer to any suitable article. Non-limiting examples may be a plastic or a polymer body, such as a substrate including polyimide, or a ceramic body. Non-limiting examples of an “object” may be for instance, a dielectric body such as a dielectric wafer, or a semiconductor body, such as a semiconductor wafer, or a fabric.

In various embodiments, the substrate may be electrically non-conductive. In the current context, a “electrically non-conductive” substrate may be a substrate having an electrical conductivity below a predetermined threshold, such as below 10⁻⁵ S/m.

In various embodiments, the substrate may include or consist of an insulator or a dielectric, such as silicon dioxide, or a plastic or a polymer, such as polyimide, or polymethyl siloxane (PDMS). In various other embodiments, the substrate may include a ceramic. In yet various other embodiments, the substrate may include or consist of a semiconductor, such as silicon. The semiconductor may be undoped. The substrate may include or consist of a fabric.

The electrically conductive layer may include any suitable electrically conductive material. The suitable electrically conductive material may have an electrical conductivity above 10⁻⁵ S/m. In various embodiments, the electrically conductive layer may include a conductive carbon material (i.e. an electrically conductive carbon material) or a conductive polymer (i.e. an electrically conductive polymer). The conductive carbon material may be any one selected from a group consisting of reduced graphene oxide, carbon nanotubes, and carbon powder. In other words, the electrically conductive layer may include any one electrically conductive material selected from a group (of electrically conductive materials) consisting of reduced graphene oxide, carbon nanotubes, carbon powder, and conductive polymers. The electrically conductive layer may include conductive carbon materials such as reduced graphene oxide, carbon nanotube, and/or conductive polymers. Reduced graphene oxide may have a value in the range from 10⁻⁵ to 10⁻⁴ S/m.

The electrically conductive layer may form a coat on the substrate.

In various embodiments, the electrically conductive material may be reduced graphene oxide (RGO). Forming the electrically conductive layer (including reduced graphene oxide) may include dipping or immersing the substrate in a mixture including graphene oxide (GO). The method may further include dipping or immersing the substrate adhered with graphene oxide in a reducing agent, such as sodium hydrophosphite monohydrate (NaH₂PO₄.H₂O), ascorbic acid, or hydrazine, so that the graphene oxide is reduced to form reduced graphene oxide.

In the current context, a “mixture” may refer to a solution or a suspension. The mixture may further include a solvent or a dispersion liquid. Graphene oxide (GO) may be hydrophilic, and may dissolve or disperse in water, which may be a solvent or a dispersion liquid.

In various embodiments, the electrically conductive material may be carbon nanotubes. Forming the electrically conductive layer (including carbon nanotubes) may include dipping or immersing the substrate in a mixture including the carbon nanotubes. The electrically conductive layer including carbon nanotubes may then be formed on the surface of the substrate. In various embodiments, the mixture may also include a surfactant to improve the dispersion of the carbon nanotubes in the dispersion liquid.

In various embodiments, the electrically conductive material may be a conductive polymer such as a polyaniline or a polythiophene. Forming the electrically conductive layer (including the conductive polymer) may include dipping or immersing the substrate in a mixture including the conductive polymer. The electrically conductive layer including the conductive polymer may then be formed on the surface of the substrate.

In the current context, a catalyst may be any substance which catalyzes the forming of the plating, i.e. the forming of the metallic layer over the substrate. The catalyst may be for instance, palladium (Pd) or any catalyst that is also suitable for use as an electrocatalyst, e.g. silver (Ag). The catalyst may remain chemically unchanged after the plating process.

In various embodiments, providing the catalyst on the electrically conductive layer may include forming the catalyst on or in contact with the electrically conductive layer. The catalyst may be formed via chemical means. In various embodiments, providing the catalyst on or in contact with the electrically conductive layer may include dipping or immersing (a stacked arrangement including) the substrate, the electrically conductive layer on the surface of the substrate, and the catalyst precursor in a catalyst solution including a catalyst precursor so that the catalyst precursor is adhered to the electrically conductive layer. Providing the catalyst on or in contact with the electrically conductive layer may further include dipping or immersing the substrate, the electrically conductive layer on the surface of the substrate, and the catalyst precursor adhered to the electrically conductive layer in a reducing agent so that the catalyst precursor is reduced to form the catalyst.

In various other embodiments, the catalyst may be provided on or in contact with the electrically conductive layer via any suitable deposition method, such as evaporation or sputtering.

In various embodiments, a density or loading of the catalyst relative to the electrically conductive layer or substrate may be less than 1 microgram per centimeter square (μg/cm²), e.g. less than 0.5 micrograms per centimeter square (μg/cm²), e.g. less than 0.1 micrograms per centimeter square (μg/cm²) e.g. less than 0.05 micrograms per centimeter square (μg/cm²), e.g. less than 0.04 micrograms per centimeter square (μg/cm²). In other words, a loading of the catalyst on the electrically conductive layer or substrate may be less than 1 microgram per centimeter square (μg/cm²), e.g. less than 0.5 micrograms per centimeter square (μg/cm²), e.g. less than 0.1 micrograms per centimeter square (μg/cm²), e.g. less than 0.05 micrograms per centimeter square (μg/cm²), e.g. less than 0.04 micrograms per centimeter square (μg/cm²).

Various embodiments may reduce a loading of the catalyst required compared to a conventional process without a prior step of forming or depositing an electrically conductive layer on the surface of the substrate. In various embodiments, the loading of the catalyst may be at least 50 times less compared to the conventional process.

In various embodiments, the metallic layer may include a metal or a metallic alloy. The metallic layer may include one or more selected from a group consisting of nickel (Ni), cobalt (Co), copper (Cu), gold (Au), silver (Ag), platinum (Pt), rhodium (Rh), ruthenium (Ru), and tin (Sn).

The electroless plating bath solution may include a metal precursor and a reducing agent. In various embodiments, for forming a metallic layer including nickel (Ni), the metal precursor may be nickel (II) sulphate hexahydrate (NiSO₄.6H₂O). The electroless plating bath solution may further include one or more inhibitors, such as sodium citrate. Sodium citrate may act as a stabilizer. A stabilizer may form a complex with metal ions in the bath so that the metal ions remain in the ionic state. The stabilizer may help to reduce the conversion of the metal ions to metal, thus reducing the rate of deposition. The electroless bath solution may also include a pH buffer, such as boric acid, to help maintain the pH of the bath solution. In electroless plating, pH control may be important to maintain plating at a stable rate.

In various embodiments, contacting the catalyst with the electroless plating bath solution may include dipping or immersing (a stacked arrangement including) the substrate, the electrically conductive layer on the surface of the substrate, the catalyst on the electrically conductive layer in the electroless plating bath solution. A temperature of the electroless plating bath solution may be any one value selected from a range from 25° C. (room temperature) to 100° C., 50° C. to 70° C., e.g. about 60° C.

In various embodiments, a pH of the electroless plating bath solution may be above 7, e.g. may be about 9.

In various embodiments, a ratio of a mass of the metallic layer formed to a mass of the catalyst provided may exceed 30, or may exceed 40, or may exceed 45. In various embodiments, a ratio of a mass of the metallic layer formed to a mass of the catalyst provided may be 47.5.

Various embodiments may relate to a plated object formed by any one method formed by any one method as described herein.

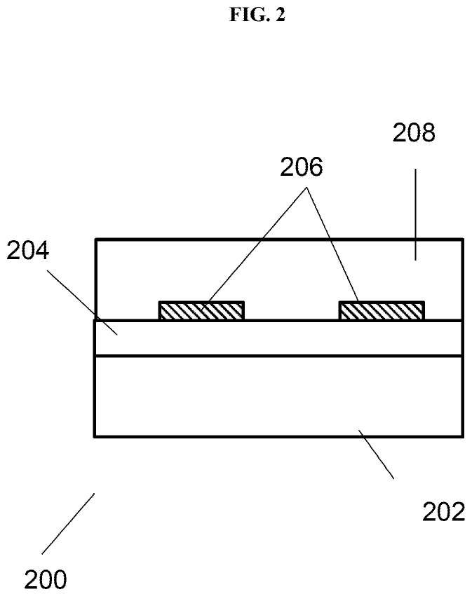

FIG. 2 is a schematic illustrating a plated object 200 according to various embodiments. The plated object 200 may include a substrate 202. The plated object 200 may also include an electrically conductive layer 204 on with the substrate 202. The plated object 200 may further include a catalyst 206 on or in contact the electrically conductive layer 204. The plated object 200 may additionally include a metallic layer 208 over the substrate 202.

In other words, a plated object 200 may in addition to the plated metallic layer 208, also include an electrically conductive layer 204 and a catalyst 206 between the plated metallic layer 208 and the substrate 202.

For avoidance of doubt, the plated object 200 may be of any shape and size. While FIG. 2 shows a planar substrate 202, it may also be envisioned that the substrate 202 may in various other embodiments be of any other shape. For instance, the substrate 202 may be spherical or may be curved.

Further, while FIG. 2 shows that the electrically conductive layer 204 and the metallic layer 208 are over an entire surface of the substrate 202, it may also be envisioned that in various embodiments, the electrically conductive layer 204 and the metallic layer 208 may also be over a portion of the substrate 202. In other words, a further portion of the substrate 202 may not be covered by the electrically conductive layer 204 and/or the metallic layer 208.

In various embodiments, the catalyst 206 may be in the form of nanostructures, such as nanoparticles. The nanostructures may be separate from one another, or may form a plurality of clusters separate from one another.

In various embodiments, the average diameter of each nanoparticle may be less than 100 nm, e.g. about 50 nm.

In various embodiments, a density or loading of the catalyst relative to the electrically conductive layer or substrate may be less than 1 microgram per centimeter square (μg/cm²), e.g. less than 0.5 micrograms per centimeter square (μg/cm²), e.g. less than 0.1 micrograms per centimeter square (μg/cm²) e.g. less than 0.05 micrograms per centimeter square (μg/cm²), e.g. less than 0.04 micrograms per centimeter square (μg/cm²). In other words, a loading of the catalyst on the electrically conductive layer or substrate may be less than 1 microgram per centimeter square (μg/cm²), e.g. less than 0.5 micrograms per centimeter square (μg/cm²), e.g. less than 0.1 micrograms per centimeter square (μg/cm²), e.g. less than 0.05 micrograms per centimeter square (μg/cm²), e.g. less than 0.04 micrograms per centimeter square (μg/cm²).

In various embodiments, the substrate 202 may be electrically non-conductive

In various embodiments, the electrically conductive layer 204 may include a conductive carbon material (i.e. an electrically conductive carbon material) or a conductive polymer (i.e. an electrically conductive polymer). The conductive carbon material may be any one selected from a group consisting of reduced graphene oxide, carbon nanotubes, and carbon powder. In other words, the electrically conductive layer may include any one electrically conductive material selected from a group consisting of reduced graphene oxide, carbon nanotubes, carbon powder, and conductive polymers. The electrically conductive layer may include conductive carbon materials such as reduced graphene oxide, carbon nanotube, and/or conductive polymers.

In various embodiments, the catalyst 206 may be palladium or silver.

In various embodiments, the metallic layer 208 may include a metal or a metallic alloy. The metallic layer 208 may include one or more elements selected from a group (of elements) consisting of nickel, cobalt, copper, gold, silver, platinum, palladium, rhodium, ruthenium, and tin. The metallic layer 208 may be or may form a continuous layer.

In various embodiments, a ratio of a mass of the metallic layer formed to a mass of the catalyst may exceed 30, or may exceed 40, or may exceed 45. In various embodiments, a ratio of a mass of the metallic layer formed to a mass of the catalyst may be 47.5.

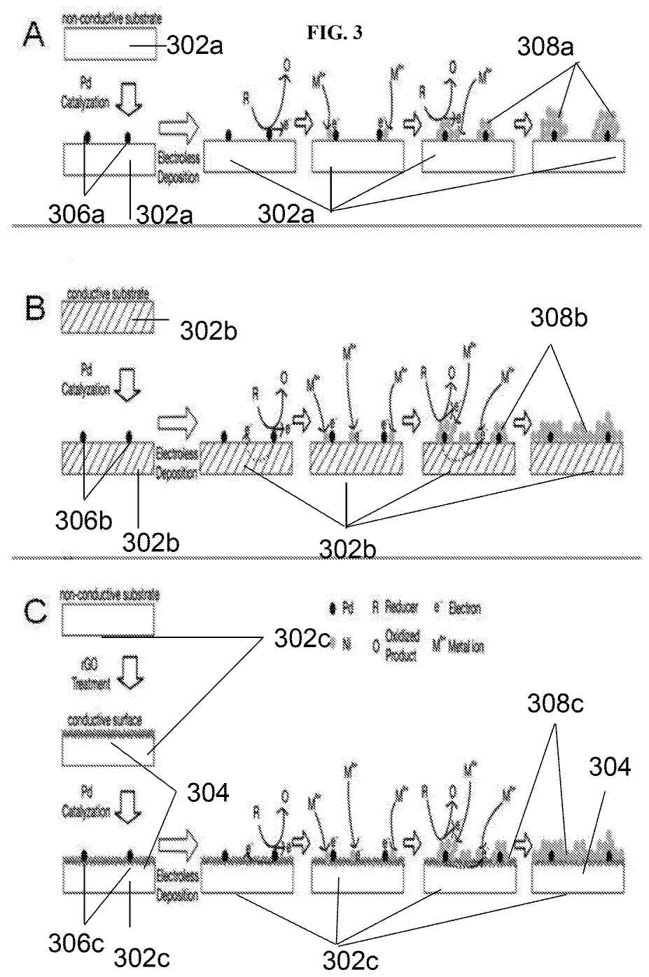

FIG. 3 is a schematic showing (A) an electroless deposition process on an electrically non-conductive substrate 302a; (B) an electroless deposition process on an electrically conductive substrate 302b; and (C) an electroless deposition process on a reduced graphene oxide (RGO) 304 coated electrically non-conductive substrate 302c according to various embodiments. FIG. 3 may show the same feature multiple times. In order to avoid clutter and improve clarity, not all instances of the same feature have been labelled.

In conventional electroless plating as shown in FIG. 3(A), dispersed catalyst nanoparticles 306a, e.g. Pd nanoparticles, having a diameter of 50-nm or more, as well as a 20% coverage of the non-conductive substrate 302a may be necessary for initiating complete and homogenous metallization of nickel (Ni) onto the non-conductive substrate 302a, such as a plastic substrate or a ceramic substrate.

For a conductive substrate 302b, after the catalyzation treatment, oxidation of the reducing agent and electron discharge may occur locally near the catalyst nanoparticle domains 306a as shown in FIG. 3(A), forming metallic nickel “islands” 308a which are non-uniform. Therefore, to uniformly metallize a non-conductive surface 302a, the catalyst nanoparticles 306a may be required to be densely distributed and loaded in a large quantity, of the order of a few μg/cm², which may increase the cost of electroless deposition.

For a conductive substrate 302b, as shown in FIG. 3(B), after catalyzation treatment, electrons discharged from the oxidation of reducing species may be transferred away or pushed through or over the conductive substrate 302b, resulting in complete and homogeneous nickel deposition on the surface to form metallic layer 308b. In fact, as demonstrated later, Ni deposition may occur on the entire conductive substrate 302b even though only some regions on the surface of the substrate 302b have Pd nanoparticles 306b.

FIG. 3(C) shows a non-conductive substrate 302c facilely functionalized with an electrically conductive layer 304 prior to loading of the Pd catalyst nanoparticles 306c according to various embodiments. The electrically conductive layer 304 may allow for electron transfer, thus enabling electroless deposition to occur efficiently throughout the non-conductive substrate 302c even with low Pd catalyst nanoparticle loading or treatment with sparsely deposited Pd catalyst.

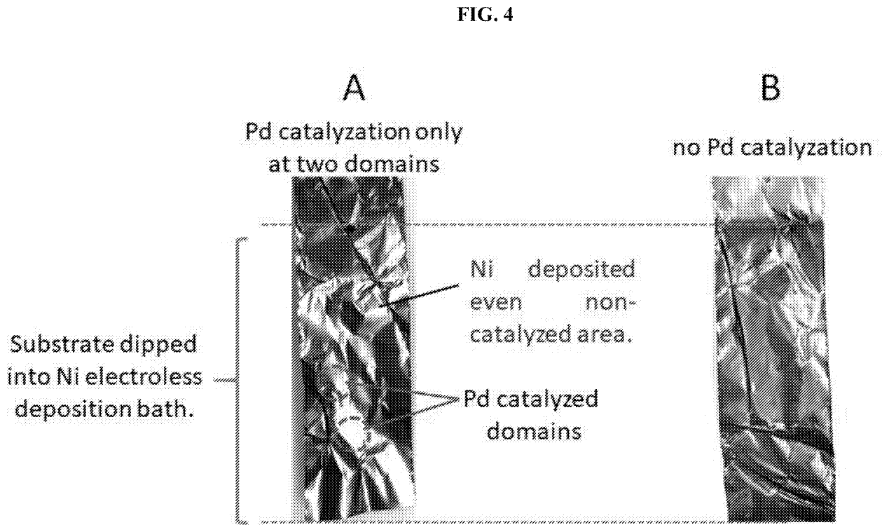

FIG. 4 illustrates (A) an image showing nickel (Ni) plated over a conductive substrate having two regions or domains of palladium (Pd) catalysts (indicated by circles) after electroless deposition, and (B) an image shows a conductive substrate without palladium (Pd) catalyst after electroless deposition. The conductive substrate may be a copper (Cu) sheet or foil.

FIG. 4(A) shows that electroless deposition may occur not only over or near the Pd-catalyzed domains, but throughout over the entire substrate. FIG. 4(B) does not show any significant plating of nickel, and is a control showing that electroless deposition may not occur without the Pd catalyst. Since the Ni redox potential is lower than Cu, Ni may not deposit on Cu substrate via galvanic displacement deposition. In addition, since Cu does not catalyze the oxidation of NaH₂PO₂ (which is the reducing agent used in the deposition bath), Ni electroless deposition may not occur on Cu substrate using NaH₂PO₂ without presence of a catalyst such as Pd.

Coating or depositing graphene may cause a plastic or ceramic surface to be electrically conductive as graphene is superconductive. The electrical conductivity property of graphene may be attributed to its unique two-dimensional (2D) structure formed by the layer of sp² hybridised carbon atoms.

However, graphene may not be suitable for solution processes because its hydrophobicity, as graphene coagulates and precipitates in water. However, graphene oxide (GO) may be hydrophilic and may dissolve or disperse well in water. Thus, GO may be coated onto a solid substrate through immersion in a GO solution. The surface of such a GO-coated substrate may be made conductive by treating it with a reducing agent solution to reduce the GO to reduced graphene oxide (RGO).

Referring to the discussion relating to FIG. 3(C), an RGO coating on an electrically non-conductive substrate may induce electroless deposition at a regular deposition rate even with very small Pd loading. In the electroless deposition process, a RGO pre-treatment (i.e. reduction of GO to rGO) step may be undertaken before the Pd catalyzation step. The inventors found that metal deposition may be feasible at a sufficient deposition rate even with an extremely low Pd loading of 3.94×10⁻² μg/cm², which may be in line with the previous discussion related to FIG. 3(C).

It has also been demonstrated that GO may be successfully reduced by NaH₂PO₂, which acts as a reducing agent, to a graphene-like structure, i.e. RGO.

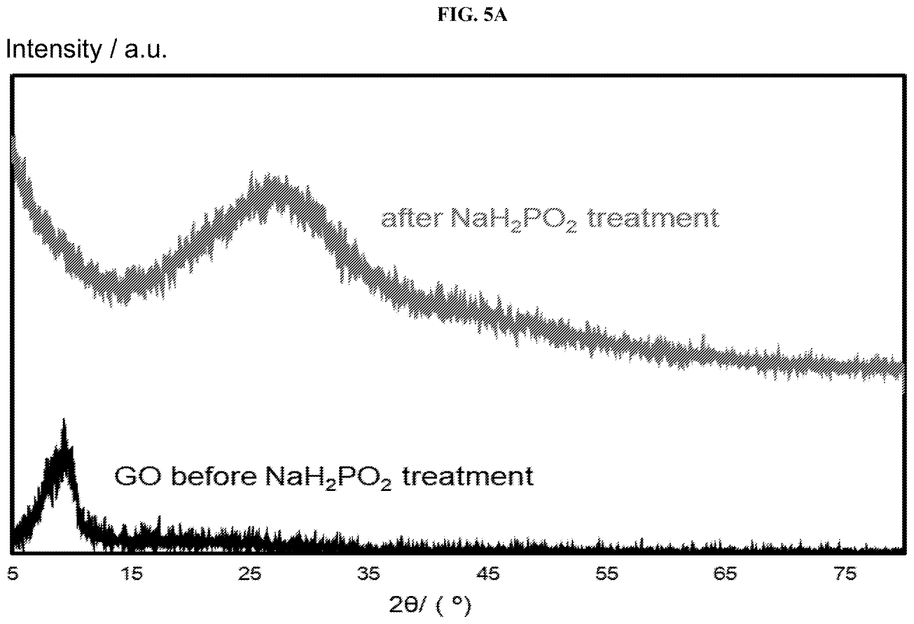

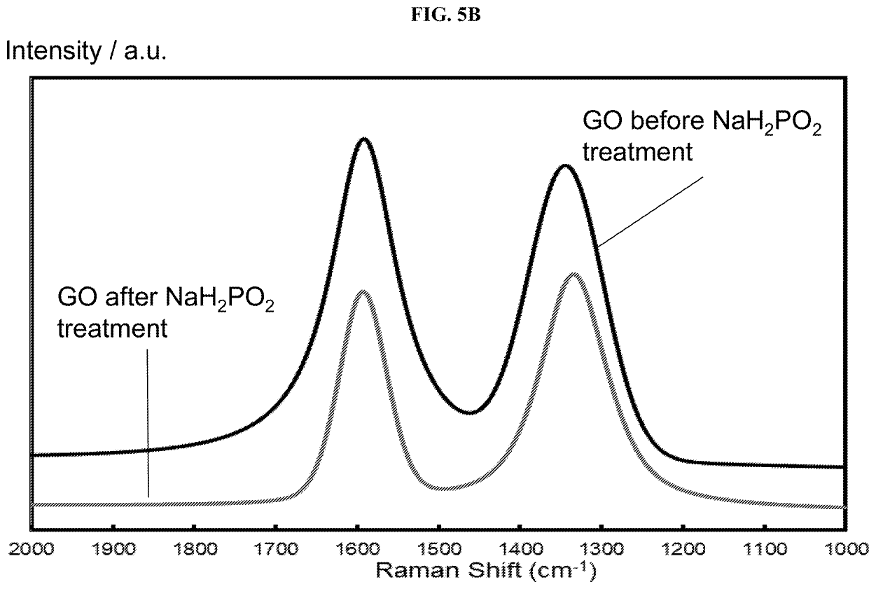

FIG. 5A is a plot of intensity (in arbitrary units or a.u.) as a function of angle 2θ (in degrees or °) showing the X-ray diffraction (XRD) patterns of graphene oxide (GO) before and after treatment with Na₂H₂PO₄ according to various embodiments.

The results of an X-ray diffraction (XRD) analysis show that the GO peak at 9.73°, which corresponds to the interlayer spacing of 0.9083 nm, disappears after the reduction treatment.

A broad peak appears at 26.22° after reduction, which may be attributed to typical graphitic (001) reflection associated with an interlayer spacing of 0.3 nm, as observed in a typical XRD profile of regular graphene or RGO. The lower peak observed in NaH₂PO₂-treated GO (26.22°) as compared with pure graphene (26.5°) may imply that phosphorus released via the decomposition of NaH₂PO₂ has been incorporated into the RGO structure, resulting in expansion of the graphene lattice.

The reduction of GO to RGO by NaH₂PO₂ may be confirmed from the Raman spectra of GO before and after the treatment. FIG. 5B is a plot of intensity (in arbitrary units or a.u.) as a function of Raman shift (in per centimeter or cm⁻¹) showing the Raman spectra of graphene oxide (GO) before and after treatment with Na₂H₂PO₄ according to various embodiments.

The ratio of the peak intensities attributed to the D band (at ˜1350 cm⁻¹) and the G band (at ˜1600 cm⁻¹), i.e. I_{D}/I_{G}, may exhibit a significant increase from 0.886 (before treatment) to 1.112 (after the treatment). This increase may indicate that the defects and degree of disorder in the GO sheet have been modified to those of regular graphitic sp2 domains as a result of the reduction of GO by NaH₂PO₂.

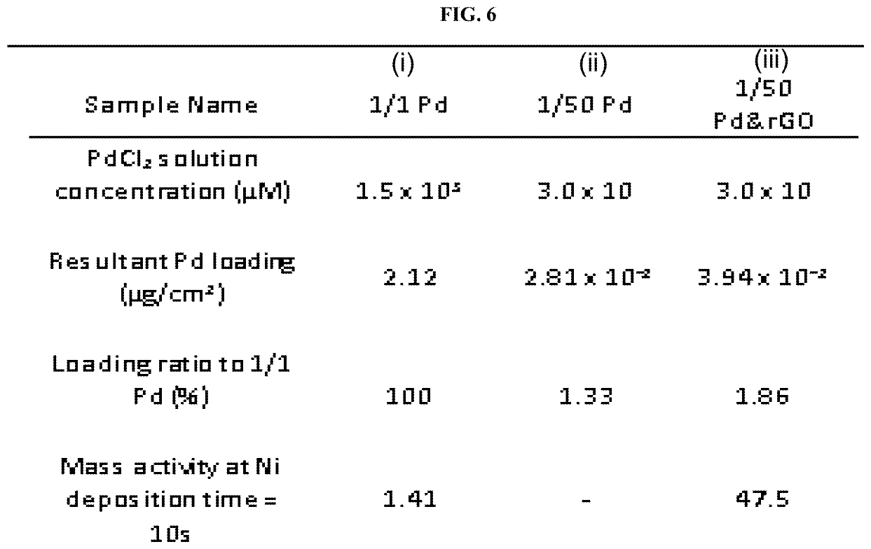

FIG. 6 shows a table show the starting conditions used to process different samples of electrically non-conductive quartz (SiO₂) substrates: Sample (i) high loading of palladium catalyst, Sample (ii) low loading of palladium catalyst, and Sample (iii) low loading of palladium catalyst but with the substrate coated or covered with reduced graphene oxide (RGO) according to various embodiments. Sample (i), also denoted as 1/1 Pd, is processed by treating with 1.5 mM, i.e. 1.5 mili-moles per liter, of PdCl₂. Sample (ii), also denoted as 1/50 Pd, is processed by treating with 30 μM, i.e. 30 micro-moles per liter, of PdCl₂. Sample (ii) is thus treated with 1/50 the concentration of PdCl₂ used to treat Sample (i). Sample (iii), also denoted as 1/50 Pd & rGO, is processed by treating with 30 μM, i.e. 30 micro-moles per liter, of PdCl₂. However, as highlighted above, the substrate of Sample (iii) may first be coated with reduced graphene oxide (RGO).

FIG. 6 shows that Sample (i) has a resultant Pd loading of 2.12 μg/cm², Sample (ii) has a resultant Pd loading of 2.81×10⁻² μm/cm², and Sample (iii) has a resultant loading of 3.94×10⁻² μm/cm². The loading ratio of Pd of Sample (ii) relative to Sample (i) is about 1.33, while the loading ratio of Pd of Sample (iii) relative to Sample (i) is about 1.86.

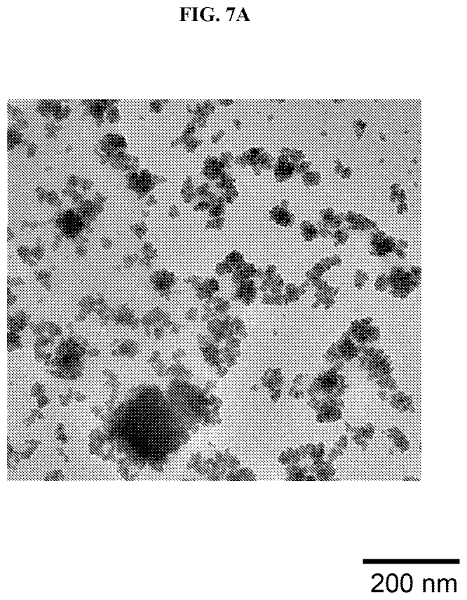

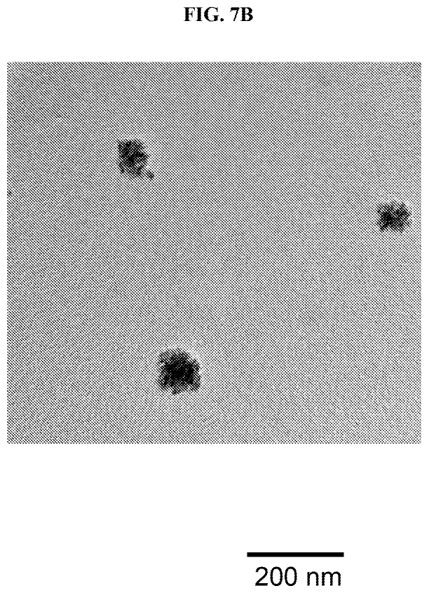

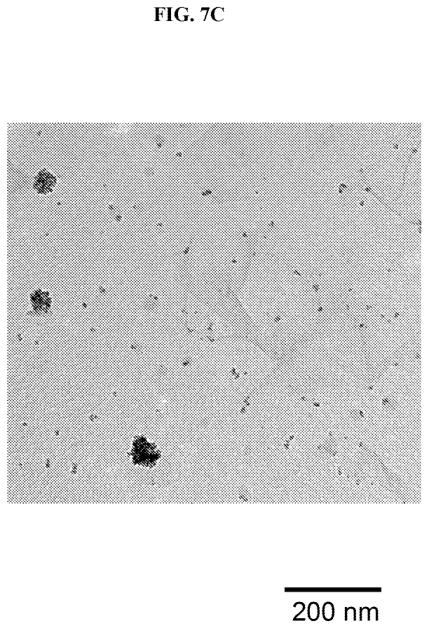

FIG. 7A shows a transmission electron microscopy (TEM) image of Sample (i) indicated in FIG. 6 after being treated with PdCl₂. FIG. 7B shows a transmission electron microscopy (TEM) image of Sample (ii) indicated in FIG. 6 after being treated with PdCl₂. FIG. 7C shows a transmission electron microscopy (TEM) image of Sample (iii) according to various embodiments indicated in FIG. 6 after being treated with PdCl₂.

The transmission electron microscopy (TEM) results show that Sample (i) shows more Pd nanoparticles being formed per unit area, with particle sizes ranging from 50 nm to 500 nm in diameter, while Sample (ii) shows fewer Pd nanoparticles being formed per unit area, with an average particle size being about 5 nm in diameter. Sample (iii) also shows fewer Pd nanoparticles being formed per unit area as compared to Sample (i), with average particle size being about 5 nm in diameter. In addition, sheet structures may also be observed in the TEM image of Sample (iii). These observations may be in line with the values indicated in FIG. 6.

Comparing FIG. 7A and FIG. 7B, and as highlighted above, Pd nanoparticles of different densities and sizes are observed. For Sample (i), the Pd nanoparticles may be comparably larger possibly because of the agglomeration of small nanoparticles to form the larger nanoparticles when coating with a higher PdCl₂ concentration. The higher PdCl₂ concentration may also result in a greater coverage of the substrate surface, with the nanoparticles as shown in the TEM grids. It can be seen from FIG. 7B and FIG. 7C that only a small amount of Pd nanoparticles with sizes of about 50 nm may be formed over the substrate surface.

Coating a substrate with RGO before applying an extremely low Pd loading may achieve an electroless deposition rate comparable to that achieved when regular Pd loading is used (but without prior coating of RGO).

FIG. 6 shows that the mass activity at 10 seconds (s) for Sample (i) is about 1.41, while the mass activity at 10 s for Sample (ii) is about 47.5. The mass activity may be defined as the ratio of mass of Ni deposited to the loading of Pd nanoparticles.

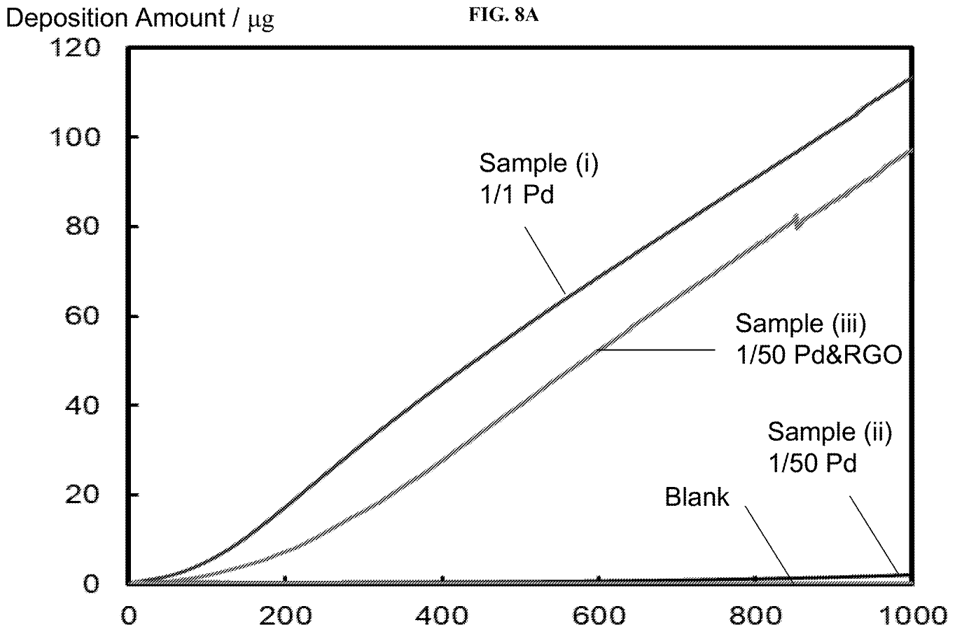

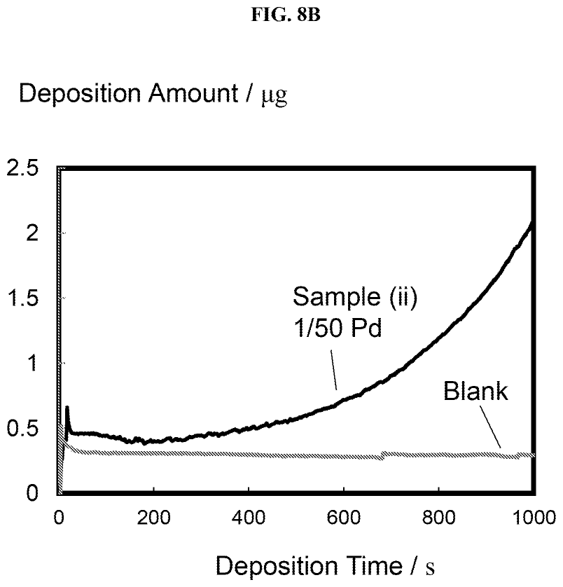

FIG. 8A is a plot of deposition amount (in micrograms or μg) as a function of deposition time (in seconds or s) showing the variation of the electroless deposition amount of nickel over the substrate over time for various samples after the different catalyzation processes according to various embodiments. The labels “Sample (i)”, “Sample (ii)” and “Sample (iii)” indicate the lines related to the respective samples shown in FIG. 6 and FIGS. 7A-C, while “Blank” refers to data for a quartz (SiO₂) substrate (without RGO but loaded with Pd). The “Blank” sample is immersed in a bath not containing nickel ions, and may serve as a reference. FIG. 8B is a magnification of the plot of FIG. 8A showing the electroless deposition amount of nickel over the substrate over time for Sample (ii) and the “Blank” Sample referred to in FIG. 8A.

As seen from FIGS. 8A-B and comparing Sample (i) and Sample (ii), when the loading of the catalyst is reduced, the electroless deposition rate of nickel may be drastically decreased. In fact, virtually no or a negligible of amount of Ni deposition may be observed for Sample (ii). The result of the reduced Pd concentration experiment, i.e. Sample (ii), may be similar to that of the measurements obtained from the “Blank” Sample. In principle, electroless Ni deposition may not occur without catalyzation.

With RGO pre-treatment (Sample (iii)), the Pd loading may be still extremely small (see FIG. 6, 3.94×10⁻² μg/cm²) for 30 μM of the PdCl₂ solution. However, the electroless deposition rate of nickel may be notably comparable to that of Sample (i) without RGO (see FIG. 8A). The low Pd loading and high electroless nickel deposition rate of Sample (iii) may indicate that RGO may be quite effective in enhancing the catalyzation process for electroless deposition and that a low amount of Pd nanoparticle catalyst may be used with prior RGO pre-treatment. Quantitatively, the mass activity, calculated by the amount of Ni deposited in μg and normalized by Pd loading in μg, may be 47.5 for Sample (iii) at a deposition time (t) of 10 s, as shown in FIG. 6. This value may be 34 times higher than that obtained for Sample (i) (the mass activity for Sample (i) is 1.41 at t=10 s).

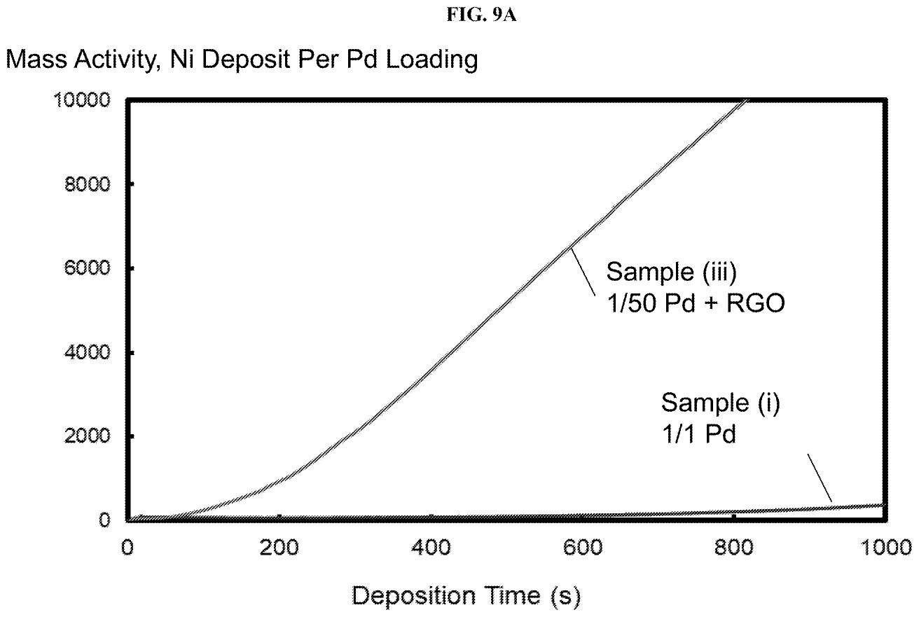

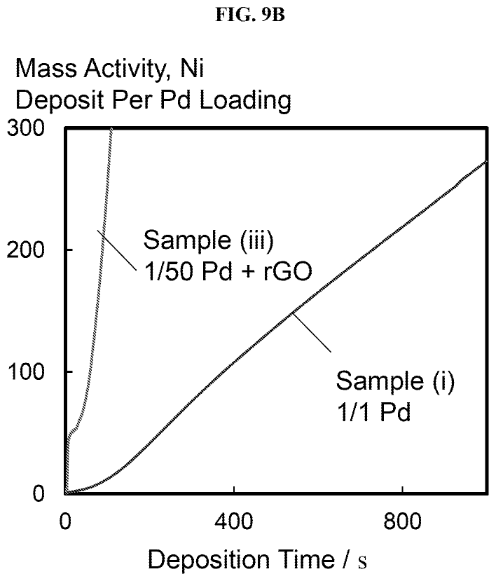

FIG. 9A is a plot of mass activity (dimensionless) as a function of deposition time (in seconds or s) showing the variation of mass activity for Sample (i) and Sample (iii) according to various embodiments as referred to in FIG. 6 over time. FIG. 9B is a magnification of the plot shown in FIG. 9A.

The enhancement of RGO on Ni deposition has also been demonstrated using another non-conductive substrate, polyimide. For the sample pre-treated with RGO and loaded with Pd catalyst, nickel may be clearly observed after electroless deposition. In contrast, for another sample without RGO pre-treatment but with similar loading of Pd catalyst, the appearance of the polyimide substrate did not change, which may indicate insufficient nickel deposition without RGO. The experiments show that RGO coating of a non-conductive surface may induce electroless deposition at regular deposition rates even with extremely small Pd loading.

RGO pre-treatment may improve the cost-effectiveness of industrial metallization processes. Pd pre-deposition has been employed in all electroless deposition processes over the past 50 years. RGO pre-treatment before Pd loading may thus improve the cost-effectiveness of this heavily used catalyst.

Experimental Details

Apparatus

The microstructures of reduced graphene oxide (RGO) and Pd nanoparticles were observed using scanning transmission electron microscopy (TEM) operated at 200 kV. The graphitic structures of graphene oxide (GO) and RGO were characterized by an X-ray diffractometer (PANalytical Empyrean) and Raman spectroscope (stellar-Pro ML150 laser, Renishaw 633 nm HeNe laser and Leica DM 2500M microscope). The amount of deposited Pd nanoparticles (Pd loading) was determined using an inductively coupled plasma mass spectrometer (ICP-MS). Ni deposition was monitored by a quartz crystal microbalance (QCM, Seiko Eg&G QCM922A) with a mirror-finished SiO₂-coated Au resonator at a basic frequency of 8.9 MHz (Seiko Eg&G QA-A9M SIO2-S(M)).

Chemicals

Graphene oxide (GO) solution (dispersion in water, 2 mg/ml), sodium hypophosphite monohydrate (NaH₂PO₂.H2O), palladium(II) chloride (PdCl₂), sodium citrate dihydrate (HOC(COONa)(CH₂COONa)₂.2H2O), boric acid (H₃BO₃) and nickel(II) sulphate hexahydrate (NiSO4₂.6H2O) were purchased from Sigma-Aldrich. The GO solution was diluted to 0.2 mg/ml with deionised (DI) water.

Reduced Graphene Oxide (RGO) Pre-treatment

A SiO₂-coated AT-cut quartz crystal substrate was washed with ethanol and left to dry in air. The washed and dried substrate was dipped into the diluted GO solution (0.2 mg/ml) for 1 min. The substrate was then air-blown and dried to remove the excess solution adhered to it. It was then dipped into a NaH₂PO₂ solution (0.2 M) for 1 min, resulting in the reduction of GO to RGO. The above-mentioned sequence was repeated five times.

Pd Catalyst Loading on a QCM Substrate

The RGO-coated substrate was dipped into PdCl₂ (1.5 mM or 30 μM with 1% hydrochloric acid (HCl)) for 10 s followed by dipping into NaH₂PO₂ (0.2 M), in sequence, for 10 s. The substrate was air-blown after every step. The stepwise Pd catalyst loading process was repeated twice. The substrate was then washed with DI water.

In Situ Measurement of Nickel Deposition by QCM

The RGO-coated and Pd-nanoparticle-deposited QCM substrate was assembled with Dip Cell (Seiko Eg&G QA-CL3) before electroless Ni deposition. The assembled unit was immersed in NaH₂PO₂ to maintain the activity of the Pd nanoparticles under aqueous conditions before testing. The Ni bath solution for electroless Ni deposition contained 0.2 M sodium citrate, 0.5 M boric acid, 15 g/L Ni (II) sulphate hexahydrate and 25 g/L sodium hypophosphite monohydrate. The pH of the Ni bath solution was adjusted to 9.0 by NaOH. During the QCM measurement, the assembled Dip Cell with quartz substrate was immersed in the electroless Ni bath solution to detect the frequency change during electroless deposition, and the temperature of the electroless Ni bath solution was maintained at 60° C. In addition, as blank sample, a quartz substrate was treated by 2 cycles of Pd (in 30 μM PdCl₂ solution) then dipped into another bath solution whose composition, pH and temperature were the same as those of the electroless Ni bath solution except that the other bath solution does not contain Ni (II) sulphate hexahydrate.

QCM is used to measure the amount of Ni deposited during the Ni electroless deposition. The deposition of Ni changes the mass of the substrate, which is detected by calculating the decrease in the frequency of the quartz by the QCM using the Sauerbrey equation.

The mass activity is expressed as the mass of Ni deposited, m_{N}, normalised by the loading of Pd nanoparticles, m_{Pd}, using the following equation:

$$Mass Activity = \frac{{m}_{Ni}}{{m}_{Pd}} \qquad ( 1 )$$

The Pd loading, m_{Pd}, was measured by ICP-MS.

Characterization of RGO Reduced by NaH₂PO₄

Since RGO deposited on quartz substrate is not thick enough for XRD and Raman spectroscopy, the reduction of GO (2 mg/ml) by NaH₂PO₂ (0.2 M) was tested after mixing with a ratio 1:9 to obtain a sufficient amount of RGO mixture gel suspended over the dispersion liquid. The mixture gel was separated from the dispersion liquid by centrifugation and filtration. Subsequently, the mixture gel was dried in a drybox for XRD and Raman spectroscopy in order to characterize the graphitic structure. The same amount of GO (2 mg/mL) was also dipped on glass slices and put in a drybox to obtain GO powder.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of forming a plated object, the method comprising:
forming an electrically conductive layer on a surface of a substrate;
providing a catalyst on the electrically conductive layer; and
contacting the catalyst with an electroless plating bath solution to form a metallic layer over the substrate, thereby forming the plated object;
wherein a density of the catalyst relative to the electrically conductive layer is less than 1 microgram per centimeter square.

2. The method according to claim 1,
wherein the substrate is electrically non-conductive.

3. The method according to claim 1,
wherein the electrically conductive layer comprises a conductive carbon material or a conductive polymer.

4. The method according to claim 3,
wherein the conductive carbon material is any one selected from a group consisting of graphene, reduced graphene oxide, carbon nanotubes, and carbon powder.

5. The method according to claim 4,
wherein the conductive carbon material is reduced graphene oxide; and
wherein forming the electrically conductive layer comprises:
dipping the substrate in a mixture comprising graphene oxide; and
dipping the substrate adhered with graphene oxide in a reducing agent so that the graphene oxide is reduced to form reduced graphene oxide.

6. The method according to claim 1,
wherein providing the catalyst on the electrically conductive layer comprises dipping or immersing the substrate, the electrically conductive layer on the surface of the substrate, in a catalyst solution comprising a catalyst precursor so that the catalyst precursor is adhered to the electrically conductive layer.

7. The method according to claim 6,
wherein providing the catalyst on the electrically conductive layer comprises dipping or immersing the substrate, the electrically conductive layer on the surface of the substrate, and the catalyst precursor adhered to the electrically conductive layer in a reducing agent so that the catalyst precursor is reduced to form the catalyst.

8. The method according to claim 1,
wherein the catalyst is palladium or silver.

9. The method according to claim 1,
wherein the electroless plating bath solution comprises a metal precursor and a reducing agent.

10. The method according to claim 1,
wherein contacting the catalyst with the electroless plating bath solution comprises dipping or immersing the substrate, the electrically conductive layer on the surface of the substrate, the catalyst on the electrically conductive layer in the electroless plating bath solution.

11. The method according to claim 10,
wherein a temperature of the electroless plating bath solution is any one value selected from a range from 25° C. to 100° C.

12. The method according to claim 1,
wherein the metallic layer comprises a metal or a metallic alloy.

13. The method according to claim 1,
wherein the metallic layer comprises one or more elements selected from a group consisting of nickel, cobalt, copper, gold, silver, platinum, palladium, rhodium, ruthenium, and tin.

14. (canceled)

15. A plated object comprising:
a substrate;
an electrically conductive layer on the substrate;
a catalyst on the electrically conductive layer; and
a metallic layer over the substrate;
wherein a density of the catalyst relative to the electrically conductive layer is less than 1 microgram per centimeter square.

16. The plated object according to claim 15,
wherein the density of the catalyst relative to the electrically conductive layer is less than 0.1 micrograms per centimeter square.

17. The plated object according to claim 15,
wherein the substrate is electrically non-conductive.

18. The plated object according to claim 15,
wherein the electrically conductive layer comprises any one electrically conductive material selected from a group consisting of graphene, reduced graphene oxide, carbon nanotubes, and conductive polymers.

19. The plated object according to claim 15,
wherein the catalyst is palladium or silver.

20. The plated object according to claim 15,
wherein the metallic layer comprises a metal or a metallic alloy.

21. The plated object according to claim 15,
wherein the metallic layer comprises one or more elements selected from a group consisting of nickel, cobalt, copper, gold, silver, platinum, palladium, rhodium, ruthenium, and tin.
